(19) United States
(12) Patent Application Publication
(10) Pub. No.: US 2012/0247641 A1
(43) Pub. Date: Oct. 4, 2012

(54) METHOD OF MELT BONDING HIGH-TEMPERATURE THERMOPLASTIC BASED HEATING ELEMENT TO A SUBSTRATE

(75) Inventors: Mary Ann Ruggiero, Toronto (CA); Reza Soltani, Richmond Hill (CA); Maizhi Yang, North York (CA); Dominic Talalla, Toronto (CA); Timothy Russell Olding, Kingston (CA); John Stockton, Hamilton (CA)

(73) Assignee: DATEC COATING CORPORATION, Mississauga, ON (CA)

(21) Appl. No.: 13/502,510

(22) PCT Filed: Oct. 21, 2010
(86) PCT No.: PCT/CA10/01652

§ 371 Date: Jun. 20, 2012

Related U.S. Application Data
(60) Provisional application No. 61/254,058, filed on Oct. 22, 2009.

(51) Int. Cl. B05D 5/00; B32B 37/02; B05D 3/02

(52) U.S. Cl. 156/60; 427/58

(57) ABSTRACT

A method for producing a thermoplastic film-substrate resistive thick film heating element is described, involving the melt bonding of an electrically insulating, optionally filled high temperature thermoplastic film to a substrate. This thick film heating element includes an optionally filled high temperature thermoplastic film-substrate onto which is deposited at least a resistive thick film, and is capable of operating over a wide range of power densities for consumer and industrial heating element applications.

### CROSS-REFERENCE TO RELATED APPLICATION

This application claims priority to U.S. Provisional Application No. 61/254,058, titled “Method of Melt Bonding High-Temperature Thermoplastic Based Heating Element to a Substrate” and filed on Oct. 22 , 2009, the entire contents of which are incorporated herein by reference.

### FIELD OF THE INVENTION

The present invention relates to film-based heating elements and their methods of production. More particularly, the invention relates to resistive heating elements formed on thermoplastic films and adapted to be melt bonded to a variety of substrates.

### BACKGROUND OF THE INVENTION

Thick film heating elements have been long sought after because of their ability to provide versatile designs, high power densities, uniform heat and rapid heating and cooling. These types of element designs are very efficient for direct heating either by placing the thick film element in contact with the component being heated or when they are required to radiate directed heat to the surroundings.

A voltage is applied to the resistive thick film either via conductive tracks or directly to the resistive thick film. This is a desirable element design, as it is lightweight, provides rapid heat up and cool down times, provides very uniform heat, and delivers power at low temperatures resulting in safer element operation.

U.S. patent application Ser. No. 12/385,889, titled “Thick Film High Temperature Thermoplastic Insulated Heating Element”, describes a thick film high temperature thermoplastic insulated resistive heating element suitable for substrates having a low melting point and/or high coefficient of thermal expansion (CTE) and a method for producing same using composite coating synthesis methods. The process for producing the heating element involves the deposition of a dielectric coating formulation comprising an electrically insulating high temperature thermoplastic polymer and filler powders in solution on the selected substrate and processing below 600° C. to melt flow the thermoplastic powder and form the composite dielectric layer coated substrate. To satisfy the electrical insulation requirements at temperature, multiple dielectric coating layer deposition and processing steps are indicated.

Although the above method provides a thick film heater that is suitable for substrates with a low melting temperature and a high CTE, there are a number of drawbacks associated with the method. Firstly, the process of depositing the insulating thermoplastic multi-layer film is complicated and time consuming. Secondly, the use of screen printing to deposit the thick film heater limits the formation of heaters on complex shapes such as non-uniformly curved or recessed surfaces. Thirdly, the electrical insulation value of the solution-deposited coating is typically lower than that of a free standing film of the same thickness prepared by another manufacturing method such as melt flow of thermoplastic polymer and filler materials together through injection molding or some other extrusion method. Finally, the process of depositing the insulating thermoplastic layer by spray coating leads to a noticeably matte or diffusive surface finish.

What is therefore needed is a method for producing a heating element that involves simpler and more rapid fabrication steps, is adaptable to curved and recessed substrate surfaces, preferably has greater electrical insulation strength per unit film thickness and provides an improved surface finish.

### SUMMARY OF THE INVENTION

Embodiments of the present invention solve the aforementioned problems by providing a process for producing a thermoplastic film based resistive thick film heating element which involves the melt bonding of a pre-fabricated electrically insulating, optionally filled high temperature thermoplastic film to a substrate. The thermoplastic film may have an electrically resistive lead free thick film located on the thermoplastic film prior to bonding, having a resistance, such that when the voltage is applied to the electrically resistive lead free thick film, it responsively heats. Alternatively, an electrically resistive lead free thick film may be deposited and processed on the thermoplastic film following the bonding step. The heating element is preferably capable of operating over a wide range of power densities for consumer and industrial heating element applications.

Accordingly, in a first aspect, there is provided a method for producing a heating element on a substrate, comprising the steps of: providing an electrically insulating film comprising a high temperature melt flowable thermoplastic polymer; melt bonding the electrically insulating film onto a surface of the substrate; and depositing an electrically resistive film onto at least a portion of the electrically insulating film; wherein a melting temperature of the substrate exceeds a temperature employed while melt bonding the electrically insulating film.

The step of melt bonding the electrically insulating film comprises the steps of: placing the electrically insulating film in contact with the surface; and heating the electrically insulating film to induce melting in the insulating film, and preferably further comprises the step of applying pressure while melt bonding the electrically resistive film. The step of melt bonding the electrically insulating film may comprise film lamination or roll to roll lamination.

The electrically insulating film is preferably heated to a temperature within a range of approximately 300-450 degrees Celsius during the step of melt bonding. Roughness of the surface may be generated prior to the step of melt bonding.

The substrate preferably comprises a material selected from the group consisting of aluminum, aluminum alloy, copper, copper alloys, and ferritic and austenitic grades of stainless steel.

The step of depositing the electrically resistive film may comprise the steps of: depositing a sol-gel formulation comprising a conductive powder; and firing the sol-gel formulation at an elevated temperature.

A conductive film comprising two or more conductive tracks is preferably deposited onto at least a portion of the electrically resistive film. Alternatively, a conductive film comprising two or more conductive tracks may be deposited onto at least a portion of the electrically insulating film prior to depositing the electrically resistive film.

A top coat layer is preferably deposited and laminated onto at least a portion of the heating element. The top coat layer is preferably selected from the group consisting of ceramic, glass, high temperature polymer, fluoropolymers, polytetrafluoroethylene, siloxanes, silicones, polyimides, and a thermoplastic material.

A thermal sensor may be adhered to a first portion of the electrically insulating film, wherein when performing step of depositing the electrically resistive film, the electrically resistive film is deposited on a second portion of the electrically insulating film. Alternatively, a thermal sensor may be deposited onto an additional film comprising a high temperature melt flowable thermoplastic, and melt bonding the additional film onto a top surface of the heating element.

The thermoplastic preferably comprises one of polyphenylene sulfide (PPS), polyphthalamide (PPA), polyarylamide (PARA), liquid crystal polymer (LCP), polysulfone (PS or PSU), polyethersulfone (PES), polyphenylsulfone (PPSU), polyamide-imide (PAI), polyimide (PI), polyetheretherketone (PEEK), polyetherketone (PEK), polyetherketoneketone (PEKK), and any combination thereof. The insulating film further comprises a filler material, such as ceramics, minerals, glass, high temperature polymer particles and a combination thereof.

The step of depositing the electrically resistive film may be performed prior the step of melt bonding, and is preferably comprises thermally processing the electrically resistive film prior to the step of melt bonding, wherein the step of thermally processing the electrically resistive film is performed at a temperature less than a melt flow temperature of the electrically insulating film.

A bond layer may be deposited onto the substrate prior to the step of melt bonding the electrically insulating film. The bond layer preferably comprises one of a melt bondable high temperature thermoplastic and mica paper.

An adhesion layer may be deposited onto the electrically insulating film prior to the step of depositing the electrically resistive film. The adhesion layer preferably comprises one of a melt bondable high temperature thermoplastic and mica paper.

The electrically insulating film and electrically resistive film are preferably substantially free of lead.

In another aspect, there is provided a melt-bondable heating element comprising: an electrically insulating film comprising a high temperature melt flowable thermoplastic polymer; and an electrically resistive film deposited onto at least a portion of the insulating film. The electrically resistive film preferably comprises a ceramic matrix and a conductive phase, and more preferably comprises a sol-gel derived composite thick film.

The heating element may further comprise a conductive film comprising two or more conductive tracks contacting at least a portion of the electrically resistive film, or a conductive film comprising two or more conductive tracks contacting at least a portion of the electrically insulating film, and further contacting the electrically resistive film.

The heating element may further comprise a top coat layer provided over at least a portion of the heating element. The top coat layer preferably comprises a material is selected from the group consisting of ceramic, glass, high temperature polymer, fluoropolymers, PTFE, siloxanes, silicones, polyimides, and thermoplastics.

The heating element may further comprise a thermal sensor located on a first portion of the electrically insulating film, wherein the electrically resistive film is provided on a second portion of the electrically insulating film.

The thermoplastic is preferably selected from the group consisting of polyphenylene sulfide (PPS), polyphthalamide (PPA), polyarylamide (PARA), liquid crystal polymer (LCP), polysulfone (PS or PSU), polyethersulfone (PES), polyphenylsulfone (PPSU), polyamide-imide (PAI), polyimide (PI), polyetheretherketone (PEEK), polyetherketone (PEK), polyetherketoneketone (PEKK), and any combination thereof.

The insulating film preferably further comprises a filler material, such as ceramics, minerals, glass, high temperature polymer particles and a combination thereof.

An adhesion layer may be provided between the electrically insulating film and the electrically resistive film, and may comprise one of a melt bondable high temperature thermoplastic and mica paper.

A further understanding of the functional and advantageous aspects of the invention can be realized by reference to the following detailed description and drawings.

### BRIEF DESCRIPTION OF THE DRAWINGS

The invention will be more fully understood from the following detailed description thereof taken in connection with the accompanying drawings, which form a part of this application, and in which:

FIG. 1 shows a top plan view of the heater element and the different optional coatings produced in accordance with the present invention.

FIG. 2 shows a cross section of the heater element taken along line I-I of FIG. 1.

FIG. 3 shows a cross section of the heater element and different optional coatings including a bonding layer to the substrate along line H of FIG. 1.

FIG. 4 shows a cross section of the heater element and different optional coatings including a bonding layer to the resistor circuit along line H of FIG. 1.

### DETAILED DESCRIPTION OF THE INVENTION

Generally speaking, the systems described herein are directed to a thick film heating element that may be melt bonded to a substrate, and methods of producing and bonding the same. As required, embodiments of the present invention are disclosed herein. However, the disclosed embodiments are merely exemplary, and it should be understood that the invention may be embodied in many various and alternative forms.

Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to heating element that may be melt bonded to a substrate, and method of producing and bonding the same.

As used herein, the terms “about” and “approximately”, when used in conjunction with ranges of dimensions of particles or other physical properties or characteristics, is meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present invention.

As used herein, the terms “comprises”, “comprising”, “including” and “includes” are to be construed as being inclusive and open ended, and not exclusive. Specifically, when used in this specification including claims, the terms “comprises” and “comprising” and variations thereof mean the specified features, steps or components are included. These terms are not to be interpreted to exclude the presence of other features, steps or components.

As used herein, the phrase “electrically insulating” means that a specified voltage may be applied across the thickness dimension of the film and electrical breakdown or unacceptable level of leakage current does not occur such that the film is termed electrically insulating.

As used herein, the phrase “high temperature thermoplastic” means a polymer that has a high melting temperature, above approximately 250° C. and retains its physical properties at elevated temperatures above approximately 180° C.

When referring to processing temperatures for both the dielectric coating and the electrically resistive lead free thick film grown on top of the dielectric coating, it will be understood that the temperatures disclosed herein are exemplary only and not limited to those temperatures or temperature ranges. The temperatures that can be used will depend on the melt flowable high temperature thermoplastic polymer being used, the filler material being mixed with the thermoplastic polymer, the particular materials used to produce the electrically resistive lead free thick film, and the nature of the substrate. For example, when the substrates on which the heater elements are being formed are made from aluminum or aluminum alloys then an upper limit of around 600° C. since the melting point of these materials is around 600° C. On the other hand, if stainless steels are the substrate material, processing temperatures higher than 600° C. could be used, but in this case the processing temperatures would be dependent more so on the nature of the thermoplastic polymer being used, the filler material and the materials used to make the electrically resistive thick film.

As used herein, the phrase “melt bonding” means a bonding process in which a first layer is melted and forms a bond with a surface upon cooling. Melt bonding may be achieved by a wide range of processes, including, but not limited to, film lamination, ultrasonic welding laser welding, and roll to roll lamination. A given melt bonding process may further include the application of pressure.

The term “thick film” as used herein is meant to refer to coatings that in general are greater than 1 um in thickness. While the terms “thick films” and “thin films” are relative, in the coatings industry, “thin film” generally refers to technologies using nano or submicron thick coatings typically done for optical and electronic applications using techniques such as sputtering, PVD, MBE etc. which in some cases lay down atomic thick layers of the coating. On the other hand, “thick film” generally refers to technologies used for coatings that are greater than 1 μm and may be produced by deposition of several successive layers using techniques such as screen printing process. While “thick film” generally refers to films with a thickness in the range from about 1 to about 500 um which would cover the range for most commercial article heating applications, it is to be understood that thicker films e.g. about 1000 μm or thicker are also covered by the term “thick film”.

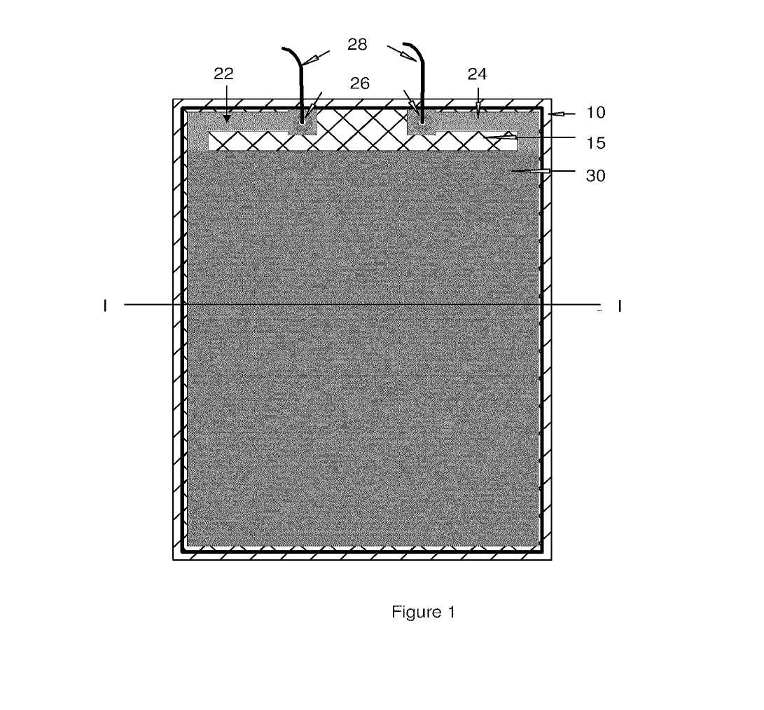

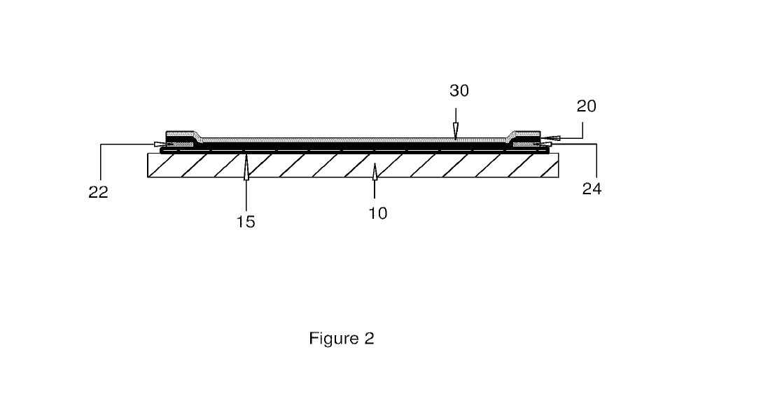

Referring to FIGS. 1 and 2, embodiments of the present invention provide a film-based heating element that is readily affixed to a substrate 10 by a melt bonding process, and a method for producing the same. The heating element comprises at least an electrically insulating film 15 and a resistive film 20. Unlike known thick film heating elements, the present heating element is affixed to substrate 10 by melt bonding electrically insulating film 15 to substrate 10. As discussed below, the structure shown in FIG. 1 may be initially provided without substrate 10, and subsequently affixed to substrate 10 through a melt bonding process.

The methods disclosed herein provide a process that significantly reduces the number of processing steps in the fabrication of a thick film resistive heating element relative to the process employed in U.S. patent application Ser. No. 12/385,889, titled “Thick Film High Temperature Thermoplastic Insulated Heating Element”. In addition, the melt bonding approach disclosed herein virtually eliminates the problem of particulate contaminants in the manufacturing environment that can compromise the integrity of electrical insulation of the thermoplastic layer which is deposited and processed from powders in solution as described in U.S. Provisional patent application Ser. No. 12/385,889. One further advantage lies in the ability to bond the thermoplastic film with the electrically resistive thick film located on said thermoplastic film to curved surface substrates. This avoids the challenging and oftentimes impractical process of reliably depositing the resistive thick film on a curved surface.

Electrically insulating film 15 preferably has a high electrical insulation strength and high thermal conductivity, and is substantially free of pin holes. Film 15 provides a thermal foundation enabling the rapid transfer of heat that is generated when a current is passed through electrically resistive film 20, while at the same time electrically isolating resistive film 20 from substrate 10. At a film thickness of 25 μm or greater, a 3000 V hi-pot strength at 250° C. is preferably obtained to meet a typical appliance regulatory standard such as IEC 60335 (International Electrotechnical Commission). As further described below, the heating element preferably comprises a conductive film for applying a voltage to the resistive film, which is preferably provided in the form of at least two conductive tracks 22 and 24. Heating element preferably further comprises a protective top coat 30.

Electrically insulating film 15 is formed at least in part from a high temperature melt-flowable thermoplastic material. The thermoplastic polymer is preferably a melt flowable, high temperature thermoplastic with a composition that preferably includes at least one of polyphenylene sulfide (PPS), polyphthalamide (PPA), polyarylamide (PARA), liquid crystal polymer (LCP), polysulfone (PS or PSU), polyethersulfone (PES), polyphenylsulfone (PPSU), polyamide-imide (PAI), polyimide (PI), polyetheretherketone (PEEK), polyetherketone (PEK), polyetherketoneketone (PEKK), or the like.

The electrically insulating film preferably also includes a filler material. The filler material is optionally added to the electrically insulating film during its manufacture and provides improved thermal expansion coefficient matching between the electrically insulating film and the additionally deposited resistive and conductive thick films. The filler material further acts to increase the thermal conductivity of electrically insulating film 15 in order to produce better heat transfer to the substrate and prevent the generation of “hot spots”. The filler material also provides supportive structure such that additionally deposited resistive or conductive thick films reliably and consistently do not sink into the electrically insulating film 15 when processed to a temperature near or above the melting temperature of the high temperature thermoplastic matrix, which avoids compromising the integrity of electrical insulation.

The filler material may include ceramics, minerals, glass or high temperature polymer (i.e. a polymer able to withstand significant temperatures without degradation and change in performance, that is preferably non-melt-flowable) particles and is added at the point of manufacture of the electrically insulating film 15. Examples of suitable ceramic materials include alumina, zirconia, silica, (optionally ceria stabilized zirconia or yttria stabilized zirconia), titania, calcium zirconate, silicon carbide, titanium nitride, nickel zinc ferrite, calcium hydroxyapatite, mica, aluminum nitride and any combinations thereof. Alumina has good thermal conductivity and dielectric strength, but mica has a flake structure that provides a beneficial combination of mechanical, electrical and thermal properties in a thermoplastic thick film.

Free-standing thermoplastic films are commercially available in a wide range of thicknesses and containing various suitable fillers. One suitable vendor is Victrex, which provides thermoplastic PEEK films. In addition, as noted above, such thermoplastic films can be custom compounded during their production with specific fillers to provide enhanced properties.

Electrically insulating film 15 may be melt bonded to a substrate material using a wide range of processes that may further include the application pressure. In a preferred embodiment, electrically insulating film 15 is bonded to substrate 10 using a lamination process.

In one embodiment, electrically insulating film 15 is melt bonded to substrate 10 prior to forming the remaining layers of the heating element. For example, electrically insulating film 15 may be laminated to substrate 10 using a laminating press. . Electrically insulating film 15 is laminated to substrate 10 by contacting the film 15 with a surface of the substrate 10. The additional components of the heating element may then be formed, as further described below.

A substantially uniform pressure is preferably applied during the melt bonding step, as electrically insulating film 15 and substrate 10 are thermally processed to a temperature sufficient to cause electrically insulating film 15 to melt flow and adhere to substrate 10. For example, a preferred temperature an electrically insulating layer comprising PEEK is in the range of approximately 350-400° C. Sufficient pressure is preferably applied to force the film into contact with the substrate, but not to squeeze it excessively so that a poor thickness profile results. (The exact pressing conditions will depend on the equipment used, although the inventors have found that a typical pressure in the range of approximately 5-30N/cm² achieves satisfactory results) In a preferred embodiment suitable for high volume production, a continuous roll-to-roll metal lamination process and/or system may be employed.

Substrate 10 has a melting temperature above that of the temperature applied during the melt bonding step and any thermal processing temperatures required in subsequent processing steps when forming the heating element. Substrate 10 is preferably a metal substrate. Metal substrates such as aluminum and aluminum alloys, copper and copper alloys, and austenitic and ferritic grades of stainless steel, such as 300 series stainless (300SS), are desirable due to their excellent thermal performance characteristics. Nonmetal substrates such as glass, glass ceramics and ceramics are also suitable for thermal bonding. Aluminum and aluminum alloys are particularly desirable because they have a thermal transfer 10 to 20 times that of stainless steel making thick film heaters on these substrates thermally fast acting and have a low density making for a very light, efficient heating element. It is to be understood that the substrate 10 may be of any material so long as it has a melting point above the maximum temperature that can be produced by the heater itself.

Preferably, the surface of substrate 10 is pre-treated prior to melt bonding to provide improved uniformity and adhesion of the coating layers from deposition to thermal processing to heating element operation. Examples of the surface treatment include sanding, rubbing, etching and sandblasting. A surface roughness (Ra) of 1 μm is preferred and can be achieved by conventional grit blasting. Clean conditions are preferred and care should be taken to avoid any contamination which would prevent adhesion of the film to the substrate.

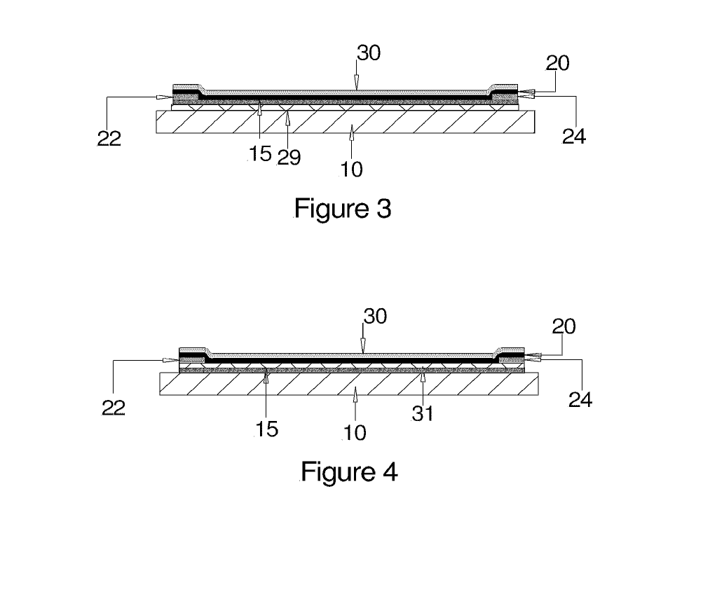

Referring to FIG. 3, a bond layer 29 may optionally be deposited on substrate 10 prior to melt bonding insulation film 15. Bond layer 29 improves the adhesion of electrically insulating film 15 film to substrate 10 and also provides improved thermal expansion matching between electrically insulating film 15 and substrate 10. Bond layer 29 preferably comprises a melt bondable high temperature polymer compatible with the electrically insulating film 15 and preferably further comprises a filler material to provide improved thermal expansion coefficient matching between substrate 10 and electrically insulating film 15. Suitable filler materials may be selected from the aforementioned list associated with electrically insulating layer 15. Bond layer 29 may be applied to substrate 10 by a wide variety of methods, including, but not limited to, spraying, screen printing, dipping, powder coating, melt bonding, and curtain coating and is preferably cured prior to melt bonding electrically insulating film 15. Bond layer 29 may be provided as a pre-fabricated film that is melt bonded to substrate 10.

Referring to FIG. 4, a similar adhesion layer 31 may be added to the surface to the electrically insulating film 15 following melt bonding. Upper adhesion layer acts to improve adhesion and thermal expansion matching between the film and conductive film 22,24 and/or resistive film 20 (further described below) to prevent cracking and delamination of the conductive and resistive films. Adhesion 31 layer is also preferably comprises a melt bondable high temperature polymer compatible with the insulating film, and may further comprise a filler material to provide improved thermal expansion coefficient matching between the resistive film 20 and/or conductive film 22,24. Suitable filler materials may be selected from the aforementioned list associated with electrically insulating layer 15. Adhesive layer 31 may be applied to electrically insulating film 15 by a wide variety of methods, including, but not limited to, spraying, including, but not limited to, spraying, screen printing, dipping, powder coating, melt bonding, and curtain coating and is preferably cured prior to deposition of conductive film 22,24 and resistive film 20. Adhesive layer 31 may be provided as a pre-fabricated film that is melt bonded to electrically insulating layer 15.

One or more of the bond layer 29 and adhesion layer 31 may alternatively comprise a non-thermoplastic film layer such as mica paper, which, for example, may be laminated to the thermoplastic film via a lamination step.

After having melt bonded electrically insulating film 15 to substrate 10 (and optionally provided bond layer 29 and/or adhesion layer 31), resistive and conductive films may be deposited and thermally processed as described in U.S. patent application Ser. No. 12/385,889, titled “Thick Film High Temperature Thermoplastic Insulated Heating Element”, filed Apr. 22, 2009, which is incorporated by reference herein in its entirety. Resistive film 20, which is preferably a thick film, may be deposited by screen printing, masked spraying, or other deposition methods onto electrically insulating film 15 and preferably processed below 600° C. to form a thick film heating element. It is to be understood that electrically resistive film 20 need not cover the entire top surface of electrically insulating film 15, as it may be preferably to further integrate a sensor (such as a temperature sensor) onto the electrically insulating film in a position that is spatially adjacent to an electrically resistive film, as further described below.

Electrically resistive film 20 is preferably a lead-free composite sol-gel based electrically resistive heater layer that is deposited onto electrically insulating film 15 and processed (fired) to a temperature below 600° C., typically in the range from about 400 to about 450° C. (but not limited thereto) to cure the coating. The temperature is selected to give a crack-free layer 20 free of volatile and/or organic constituents. The composite sol-gel resistive thick layer 20 may be made according to the teachings of U.S. Pat. No. 6,736,997 issued on May 18, 2004 and U.S. Pat. No. 7,459,104 issued Dec. 2, 2008 both to Olding et al., (which are both incorporated herein in their entirety by reference) and the resistive powder can be one or graphite, silver, nickel, doped tin oxide or any other suitable resistive material, as described in the Olding patent publication.

The sol-gel formulation of electrically resistive film 20 is preferable as it does not require the addition of lead or any other hazardous material to process the heating element below 600° C., in keeping with the RoHS Directive adopted by Europe in 2006. Other conductive and resistive thick film formulations with a high temperature polymer or inorganic binder may also be utilized.

The sol-gel formulation is a solution containing reactive metal organic or metal salt sol-gel precursors that are thermally processed to form a ceramic material such as alumina, silica, zirconia, (optionally ceria stabilized zirconia or yttria stabilized zirconia), titania, calcium zirconate, silicon carbide, titanium nitride, nickel zinc ferrite, calcium hydroxyapatite and any combinations thereof. The sol gel process involves the preparation of a stable liquid solution or “sol” containing inorganic metal salts or metal organic compounds such as metal alkoxides. The sol is then deposited on a substrate material and undergoes a transition to form a solid gel phase. With further drying and firing at elevated temperatures, the “gel” is converted into a ceramic coating. The sol gel formulation may be an organometallic solution or a salt solution. The sol-gel formulation may be an aqueous solution, an organic solution or mixtures thereof.

A conductive film, which is preferably a thick film, may be deposited to provide the conductive strips/bus bars 22 and 24 for making an electrical connection to the resistive thick film element 20. Conductive strips 22 and 24 are deposited either before or after deposition of electrically resistive film 20 (in FIG. 2, conductive strips 22 and 24 are shown as having been deposited before the deposition of electrically resistive layer 15). Electrical contacts 26 and wires 28 may be further provided to apply a voltage or inject a current into electrically resistive film 15.

Conductive strips 22 and 24 can be processed using a separate processing step typically at a temperature of 450° C. or less or alternatively it can be co-fired with electrically resistive film 15. The conductive thick film is preferable lead-free and can be made from a composite sol-gel formulation that contains nickel, silver or any other suitable conductive powder or flake material. The sol-gel formulation may be prepared from, but is not limited to, alumina, silica, zirconia, or titania metal organic precursors stabilized in solution. While FIGS. 1 and 2 show a specific size, shape and orientation of conductive strips 22 and 24, those skilled in the art will readily appreciate that two or more conductive strips adapted to contact electrically resistive film 20 may be provided in a wide array of sizes, shapes, orientations and compositions.

Alternately, conductive strips 22 and 24 may be produced from any commercially available thick film product that can be thermally processed at a temperature less than a melting temperature of the other components of the heating element and substrate (preferably approximately 450° C. or less). One suitable thick film product is Parmod VLT, which contains a reactive silver metal organic, and silver flake or powder dispersed in a vehicle and can be fired at a temperature typically between about 200-450° C. While Parmod VLT is a preferred commercially available conductive thick film product, it should be understood that other suitable conductive thick film products may be used, and that the embodiments disclosed herein are not limited to these example products. Since the conductive film may not be exposed to the heating temperatures in the resistive thick film, some high temperature polyimide or polyamide-imide based silver thick film products may also be suitable for use in producing conductive strips 22 and 24.

A protective top coat layer 30, which may contain ceramic, glass or high temperature polymer (fluoropolymers such as polytetrafluoroethylene (PTFE), siloxanes, silicones, polyimides, etc.) or a or top thermoplastic film layer, may optionally be deposited or laminated respectively onto the electrically resistive film to provide oxidation protection, moisture resistance, mechanical support and protection, and electrical insulation.

A thermal sensor, such as a thermistor, thermocouple, capacitive sensor, or other suitable device, may optionally be placed on electrical insulating film 15 prior to lamination. In a preferred embodiment of the invention, a thick film thermistor is deposited by screen print onto a first portion of electrically insulating film 15, and where the electrically resistive film 20 is deposited in a second portion. Preferably, to provide optimal thermal response, the first portion is substantially adjacent to the second portion. A protective top coat layer may then be laminated on top so that the temperature sensor is sandwiched between the protective top coat and electrically insulating thermoplastic film 15.

Alternatively, a thermal sensor may be screen printed on a separate film and laminated directly on top of the electrically resistive film, thereby providing both an insulator and sensor. A top coat can be optionally further laminated on top of the sensor.

In a preferred embodiment, either of the resistive thick film 20, conductive thick film 22,24, and optionally the subsequent top coat 30, may be formulated, deposited and thermally processed onto electrically insulating film 15 prior to its lamination to substrate 10. In order to avoid thermally bonding the electrically insulating film to a supportive base during this process, the resistive film 15, conductive film 20 and more preferably the top coat 30 are deposited and thermally processed at a temperature below the melt flow temperature of the thermoplastic film.

For example, electrically resistive film 20 may be deposited onto electrically insulating film 15 using methods described in U.S. patent application Ser. No. 12/385,889, provided that a suitable sol-gel, such as a colloidal silica sol-gel, is selected that is compatible with thermal processing of the electrically resistive film at a temperature that is less than that of the melt flow temperature of electrically insulating layer 15. Additional layers including conductive strips 22 and 24 and top layer 30 may also be deposited prior to lamination. The entire film structure consisting of a combination of electrically insulating film 10, electrically resistive film 20, and conductive film (e.g. strips 22 and 24) and/or top layer 30 may then be melt bonded to substrate 10. For example, the pre-assembled structure may be placed in contact with substrate 10 and thermally processed (preferably under pressure) to a temperature in the range of 300-450° C. to laminate the heating element the substrate. Sufficient pressure should be applied to force the film into intimate contact with the substrate, but not to squeeze it excessively to prevent deformation of the heater. Additional resistive thick film, conductive thick film and/or top coat layers may be then deposited on the surface of the laminate and processed as described previously.

The aforementioned heating element comprising electrically insulating film 15 having at least electrically resistive film 20 deposited thereon, and its method of fabrication, is well suited to forming heating elements on substrate surfaces that have curved or complex surfaces, or are recessed or difficult to access. Such surfaces are not amenable to prior art methods of forming heating elements that require spray coating and subsequent screen printing of layers forming the heating element. One example of this embodiment is a heating element bonded to the inner curved surface of a u-shaped aluminum die component. Another example is a heating element bonded to the outer surface of a metal pipe with a non-uniform contour with fluid flowing through the pipe.

As noted above, the known method of spray deposition of an electrically insulating coating formulation comprising electrically insulating high temperature thermoplastic polymer and filler powders in solution on the selected substrate results in a coating surface texture that is matte in appearance. This can be advantageous in terms of improved adhesion of subsequently deposited resistive and conductive thick films. However, a better thickness uniformity and hence electrical reliability of resistive and conductive thick films can be obtained when depositing said films on the pre-manufactured thermoplastic film. Furthermore, the latter improvement provides significantly improved surface quality, which can be quantified in terms of an improved specular reflection coefficient and lower diffuse reflectance. This distinguishing feature of a heating element produced according to embodiments of the present invention therefore provides a product having a superior cosmetic appearance.

The present invention will now be illustrated with the following non-limiting examples. It will be appreciated that these examples and the processing conditions for making the heater elements are for purposes of illustration only and not meant to limit the scope of the present invention. For example, the substrates used, the constituents used to make each of the different layers will determine the processing temperatures but it will be appreciated that variations in substrate material, thermoplastic polymer, filler material, resistive heater layer composition may be accompanied by different processing temperatures and other conditions.

### EXAMPLES

### Example 1

### Heater Element Printed on a Laminated Dielectric on Aluminum Substrate

The aluminum substrate is grit blasted to RA of 1 um and degreased using normal degreasing techniques to remove all traces of grease and surface impurities. A 125 um thick filled PEEK film containing approximately 20 wt % mineral particles is laminated to the substrate in a press at a uniform pressure of 10N/cm² and a temperature of 400° C. for a sufficient time to melt bend the coating. A conductive circuit for the heater is applied to the laminated film surface by screen printing a silver conductor paste such as Parmod DAA100 and processed at a temperature of 400° C. The resistive track is screen printed on the conductor using a composite sol-gel resistor paste made from graphite and thermally processed at 400° C. A 25 um thick filled PEEK film containing approximately 20 wt % mineral particles is laminated on top of the heater circuit in a press at a uniform pressure of 10N/cm² and a temperature of 400° C.

### Example 2

### Heater Element Laminated on Aluminum Substrate

A conductive circuit for the heater is deposited on a 125 um thick filled PEEK film containing approximately 20 wt % mineral particles by first screen printing a silver conductor paste such as Parmod DAA100. The conductor is processed at a temperature 250° C. The resistive track is screen printed on the conductor using a composite sol-gel resistor paste made from graphite and thermally processed at 250° C. The aluminum substrate is prepared by grit blasting the surface to a surface finish (RA) of 1 um and degreased using normal degreasing techniques to remove all traces of grease and surface impurities. The heater film is laminated to the prepared substrate in a press at a uniform pressure of approximately 5N/cm². A 25 um thick filled PEEK film containing approximately 20 wt % mineral particles is laminated on top of the heater circuit in a press at a uniform pressure of 10N/cm² and a temperature of 400° C.

### Example 3

### Heater Element Printed on a Laminated Dielectric with Sol-Gel Composite Bond Layer on Aluminum Substrate

A heater element was produced as in example 1, with the exception that a bond layer was deposited and cured on the aluminum substrate and the thermoplastic film was subsequently laminated to the bond layer surface of the coated substrate (see FIG. 3). The bond layer consisted of silica sol-gel formulation containing 3 um alumina powder which was spray-deposited on the aluminum substrate, dried at 90° C. in a drying oven, and fired at 400° C. in a furnace.

### Example 4

### Heater Element Printed on a Mica Paper Bond Layer Laminated to a Thermoplastic Dielectric Film on an Aluminum Substrate

A heater element was produced as in example 1, with the exception that a mica paper bond layer was included in the process of laminating the thermoplastic film to the aluminum substrate, so that the mica paper was laminated to one surface of the thermoplastic film and the aluminum substrate to the other (see FIG. 4).

As used herein, the terms “comprises”, “comprising”, “including” and “includes” are to be construed as being inclusive and open ended, and not exclusive. Specifically, when used in this specification including claims, the terms “comprises” and “comprising” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. A method for producing a heating element on a substrate, comprising the steps of:
providing an electrically insulating film comprising a high temperature melt flowable thermoplastic polymer;
melt bonding said electrically insulating film onto a surface of said substrate; and
depositing an electrically resistive film onto at least a portion of said electrically insulating film;
wherein a melting temperature of said substrate exceeds a temperature employed while melt bonding said electrically insulating film.

2. The method according to claim 1 where said step of melt bonding said electrically insulating film comprises the steps of:
placing said electrically insulating film in contact with said surface; and
heating said electrically insulating film to induce melting in said insulating film.

3. The method according to claim 1 or 2 further comprising the step of applying pressure while melt bonding said electrically resistive film.

4. The method according to claim 1 or 2 wherein said step of melt bonding said electrically insulating film comprises a lamination process selected from the group consisting of film lamination and roll to roll lamination.

5. The method according to any one of claims 1 to 4 wherein said electrically insulating film is heated to a temperature within a range of approximately 300-450 degrees Celsius during said step of melt bonding.

6. The method according to any one of claims 1 to 5 wherein said substrate comprises a material selected from the group consisting of aluminum, aluminum alloy, copper, copper alloys, and ferritic and austenitic grades of stainless steel.

7. The method according to any one of claims 1 to 6 wherein said step of depositing said electrically resistive film comprises the steps of:
depositing a sol-gel formulation comprising a conductive powder; and
firing said sol-gel formulation at an elevated temperature.

8. The method according to any one of claims 1 to 7 further comprising the step of depositing a conductive film comprising two or more conductive tracks onto at least a portion of said electrically resistive film.

9. The method according to any one of claims 1 to 7 further comprising the step of depositing a conductive film comprising two or more conductive tracks onto at least a portion of said electrically insulating film prior to depositing said electrically resistive film.

10. The method according to any one of claims 1 to 9 further comprising one of depositing and laminating a protective top coat layer onto at least a portion of said heating element.

11. The method according to claim 10 wherein said top coat layer is selected from the group consisting of ceramics, glasses, and high temperature polymers.

12. The method according to any one of claims 1 to 11 further comprising the step of adhering a thermal sensor to a first portion of said electrically insulating film, wherein when performing step of depositing said electrically resistive film, said electrically resistive film is deposited on a second portion of said electrically insulating film.

13. The method according to any one of claims 1 to 11 further comprising the step of depositing a thermal sensor onto an additional film comprising a high temperature melt flowable thermoplastic, and melt bonding said additional film onto a top surface of said heating element.

14. The method according to any one of claims 1 to 13 wherein said thermoplastic comprises one of polyphenylene sulfide (PPS), polyphthalamide (PPA), polyarylamide (PARA), liquid crystal polymer (LCP), polysulfone (PS or PSU), polyethersulfone (PES), polyphenylsulfone (PPSU), polyamide-imide (PAI), polyimide (PI), polyetheretherketone (PEEK), polyetherketone (PEK), polyetherketoneketone (PEKK), and any combination thereof.

15. The method according to any one of claims 1 to 14 wherein said insulating film further comprises a filler material.

16. The method according to claim 15 wherein said filler material is selected from the group consisting of ceramics, minerals, glass, high temperature polymer particles and a combination thereof.

17. The method according to any one of claims 1 to 16 wherein said step of depositing said electrically resistive film is performed prior said step of melt bonding.

18. The method according to claim 17 further comprising the step of thermally processing said electrically resistive film prior to said step of melt bonding, wherein said step of thermally processing said electrically resistive film is performed at a temperature less than a melt flow temperature of said electrically insulating film.

19. The method according to any one of claims 1 to 18 further comprising the step of depositing a bond layer onto said substrate prior to said step of melt bonding said electrically insulating film.

20. The method according to claim 19 wherein said bond layer comprises one of a melt bondable high temperature thermoplastic and mica paper.

21. The method according to any one of claims 1 to 19 further comprising the step of depositing an adhesion layer onto said electrically insulating film prior to said step of depositing said electrically resistive film.

22. The method according to claim 21 wherein said adhesion layer comprises one of a melt bondable high temperature thermoplastic and mica paper.
